(19) United States
(12) Patent Application Publication
(10) Pub. No.: US 2022/0053124 A1
(43) Pub. Date: Feb. 17, 2022

(54) SYSTEM AND METHOD FOR PROCESSING INFORMATION FROM A ROTATABLE CAMERA

(71) Applicant: Denso International America, Inc., Southfield, MI (US)

(72) Inventor: Yumeng Zhou, Southfield, MI (US)

(21) Appl. No.: 16/992,711

(22) Filed: Aug. 13, 2020

(51) Int. Cl. H04N 5/232; G06T 7/70

(52) U.S. Cl. CPC H04N 5/23229; H04N 5/2253; G06T 7/70; H04N 5/23299

(57) ABSTRACT

A system for processing information from a rotatable camera may include one or more processors and a memory one or more modules. The modules cause the processor(s) to, at a first time, obtain a first image of a first field-of-view from the rotatable camera having a first object set and generate an imaginary image that includes the first object set with the position of the first object set being based on the first image. At a second time, the modules cause the processor(s) to obtain a second image from the rotatable camera of a second field-of-view having a second object set, update the imaginary image to include the second object set with the position of the second object set being based on the second image, and update the position of the first object set in the imaginary image based on a predicted position.

### TECHNICAL FIELD

The subject matter described herein relates, in general, to systems and methods for processing information from a camera and, more specifically, systems and methods for processing information from a rotatable camera.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

When piloting a moving object, such as a vehicle, human operators collect visual information regarding the surrounding environment through their eyes. Typically, human operators routinely and selectively change their gaze to collect information of the surrounding environment from different viewpoints. Based on the environment, speed of the vehicle, and other factors, the human operator may adjust which areas of the environment they focus their gaze on. For example, when operating in an environment that has numerous moving objects, the human operator may broadly adjust their gaze rapidly to collect information from abroad field-of-view. Conversely, when operating in an environment that has few objects, the human operator may mainly direct their gaze in a more focused and narrower field-of-view.

Some vehicles include one or more cameras for capturing images of the environment surrounding the vehicle. Images captured by the cameras may then be processed to determine the presence of one or more objects. Information regarding the presence of one or more objects may be provided to an object tracking system that can track these objects. Even further downstream, the output of the object tracking system may be provided to a motion planning system that can control the movement of the vehicle to avoid colliding with one or more objects external to the vehicle.

However, some cameras utilized on vehicles are fixed cameras that have only a fixed field-of-view. As such, to capture information from images from a broad field-of-view surrounding the vehicle, numerous fixed cameras have to be utilized. As such, a single vehicle may have numerous cameras positioned at different locations of the vehicle to capture different fields-of-view external to the vehicle. While this arrangement is successful in capturing a broad field-of-view, this arrangement has several drawbacks, including the need to process significant amounts of information captured from each of these fixed cameras and increased costs associated with having numerous cameras mounted to the vehicle.

### SUMMARY

This section generally summarizes the disclosure and is not a comprehensive explanation of its full scope or all its features.

In one embodiment, a system for processing information from a rotatable camera may include one or more processors and a memory in communication with the one or more processors. The memory may include one or more modules that include instructions that cause the one or more processors to perform several different functions. In one example, the memory may include an image acquisition module that causes the one or more processors to obtain, at a first time, a first image of a first field-of-view from the rotatable camera when the rotatable camera is in a first position. The first image may have a first object set, which may be one or more objects located within the image.

Also occurring at or near the first time, an imaginary image module may cause the one or more processors to generate an imaginary image that includes the first object set. Moreover, the imaginary image may be a simplified electronic image that includes the first object set. As such, objects within the first object set are located within the imaginary image. The position of the object from the first object set is based on the first image. Moreover, the position of the objects in the first image will be utilized to determine the position of the objects within the imaginary image.

At a second time, which may proceed after the first time, the image acquisition module causes the one or more processors to obtain a second image from the rotatable camera when the rotatable camera is in a second position of a second field-of-view. Essentially, the rotatable camera may be rotated such that the field-of-view of the rotatable camera is changed to the second field-of-view. The second image may include a second object set Like before, the second object set may include one or more objects identified within the second image. In some cases, the objects of the first object set may also be present in the second object set.

Also occurring near the second time, the imaginary image module causes the one or more processors to update the imaginary image to include the second object set. As such, the imaginary image will now include objects from the second object set, with the position of the second objects within the imaginary image being based on their positions in the second image. As such, the imaginary image may include a field-of-view that may include both the first field-of-view and the second field-of-view.

Additionally, also near the second time, the imaginary image module causes the one or more processors to update the position of the first object set in the imaginary image based on a predicted position of the first object set at the second time. As such, the objects of the first object set, which may not be present in the second image, have their positions updated in the imaginary image based on a prediction of their movement. As such, while the rotatable camera may not be able to capture images that include the field-of-view encompassing the imaginary image, the system can utilize images captured by the rotatable camera at different points in time to update the imaginary image with either the actual position of objects or their predicted positions. By so doing, one rotatable camera may be able to replace several fixed cameras.

In another embodiment related to a method for processing information from a rotatable camera, the method includes the steps of obtaining, at a first time, a first image of a first field-of-view from the rotatable camera when the rotatable camera is in a first position Like before, the first image has a first object set that may be one or more objects identified within the first image. The method, also at or near the first time, performs the step of generating an imaginary image that includes the first object set. The position of the objects of the first object set within the imaginary image are based on the position of the objects from the first image.

At a second time, the method performs the step of obtaining a second image from the rotatable camera when the rotatable camera is in a second position of a second field-of-view. The second image has a second object set, which may be one or more objects identified within the second image. At or near the second time, the method performs the step of updating the imaginary image to include the second object set with the positions of the second objects based on the second image. Additionally, also at or near the second time, the method performs the step of updating the position of the first object set in the imaginary image based on a predicted position of the first object set at the second time.

In yet another embodiment, a non-transitory computer-readable medium storing instructions that, when executed by one or more processors, cause the one or more processors to obtain, at a first time, a first image of a first field-of-view from the rotatable camera when the rotatable camera is in a first position Like before, the first image has a first object set that may be one or more objects identified within the first image. In addition, at or near the first time, the instructions cause the one or more processors to generate an imaginary image that includes the first object set. The position of the objects of the first object set within the imaginary image is based on the position of the objects from the first image.

At a second time, the instructions cause the one or more processors to obtain a second image from the rotatable camera when the rotatable camera is in a second position of a second field-of-view. The second image has a second object set, which may be one or more objects identified within the second image. At or near the second time, the instructions cause the one or more processors to update the imaginary image to include the second object set with the positions of the second objects that thing based on the second image. Additionally, also at or near the second time, the instructions cause the one or more processors to update the position of the first object set in the imaginary image based on a predicted position of the first object set at the second time.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle having an information processing system for processing information from a rotatable camera.

FIG. 2 illustrates a more detailed block diagram of the information processing system for processing information from a rotatable camera.

FIG. 3 illustrates an example of a rotatable camera.

FIGS. 4A-4C illustrate examples of different fields-of-view captured from a rotatable camera.

FIGS. 5A and 5B illustrate different fields-of-view being captured by a rotatable camera at different moments in time.

FIGS. 6A and 6B illustrate an image captured by the rotatable camera and an imaginary image based on the image captured from the rotatable camera as produced by the information processing system, respectively.

FIG. 7 illustrates an example of an imaginary image that has a field-of-view that is greater than the field-of-view of any one image captured by the rotatable camera.

FIG. 8 illustrates two images captured by the rotatable camera at two different times utilized to train a prediction model for predicting the movement of objects within an imaginary image.

FIGS. 9A-9D illustrate different examples of different scenarios for controlling the movement of the rotatable camera to focus on specific areas within one or more fields-of-view.

FIGS. 10A and 10B illustrate an example at two different moments in time of a field-of-view captured by the rotatable camera.

FIGS. 11 and 12 illustrate an image of a scene that contains one or more objects of interest and an example scenario for controlling the movement of the rotatable camera to focus on the one or more objects of interest at the appropriate time.

FIG. 13 illustrates a method for processing information from a rotatable camera.

### DETAILED DESCRIPTION

Described are a system and related method for processing information obtained from a rotatable camera. Currently, some vehicles include fixed cameras that have a fixed field-of-view. As such, because their field-of-view is fixed, numerous fixed cameras must be mounted to the vehicle to obtain images of the environment surrounding the vehicle. This has several drawbacks, including higher costs due to the need for numerous fixed cameras and significantly higher processing loads because the use of numerous cameras generates numerous images that must be processed.

The system and method described in this specification take a different approach. Moreover, the system may include a rotatable camera. In one example, the rotatable camera may be mounted to a vehicle. Based on the rotational position of the rotatable camera, the rotatable camera can capture images from a plurality of different points of view. The system obtains the images from the rotatable camera and based on the images, can generate an imaginary image that contains one or more objects found in the images captured by the rotatable camera. The imaginary image may have a field-of-view that is much wider than the field-of-view of any one image captured by the rotatable camera. In one example, the field-of-view of the imaginary image may be similar to the rotational field-of-view of the rotatable camera. In other words, assume, for example, that the field-of-view of the captured image is 150°, but that the rotatable camera can, due to its ability to rotate, capture multiple images from multiple fields-of-view totaling a 300° field-of-view. The imaginary image would combine the images captured by the rotatable camera to generate an imaginary image that is 300°.

The system updates the imaginary image as the rotatable camera captures images. In one example, objects located within the images are placed within the imaginary image based on their position within the captured image. As the rotatable camera rotates to another field-of-view, the objects in the imaginary image from the previous image may be moved based on a predicted movement of the objects. A prediction model may generate the predicted movement, which may be a deep neural network. As the camera turns to the previous field-of-view, the predicted position of the objects can be updated with the actual position of the objects.

Additionally, the system and method may choose which areas of the environment surrounding the vehicle to focus on. For example, if the vehicle is traveling at a relatively fast speed, the system and method may choose to focus the rotatable camera in an area in front of the vehicle. If the vehicle is operating slowly in an object rich environment, the system and method may broaden the areas of the environment surrounding the vehicle to focus on, to capture the movement of objects. Additionally or alternatively, the system may be able to determine the presence of important objects, such as stop signs, stoplights, pedestrians, and the like, and, as the vehicle approaches these objects, may change the position of the rotatable camera to focus more on these objects.

As such, the system and method allow for the processing of information from a rotatable camera such that the rotatable camera can detect objects from a wide field-of-view—wider than any image captured from a fixed camera. By so doing, fewer cameras can be utilized and less information is generated to be processed, thus improving the performance and the cost to implement such a system.

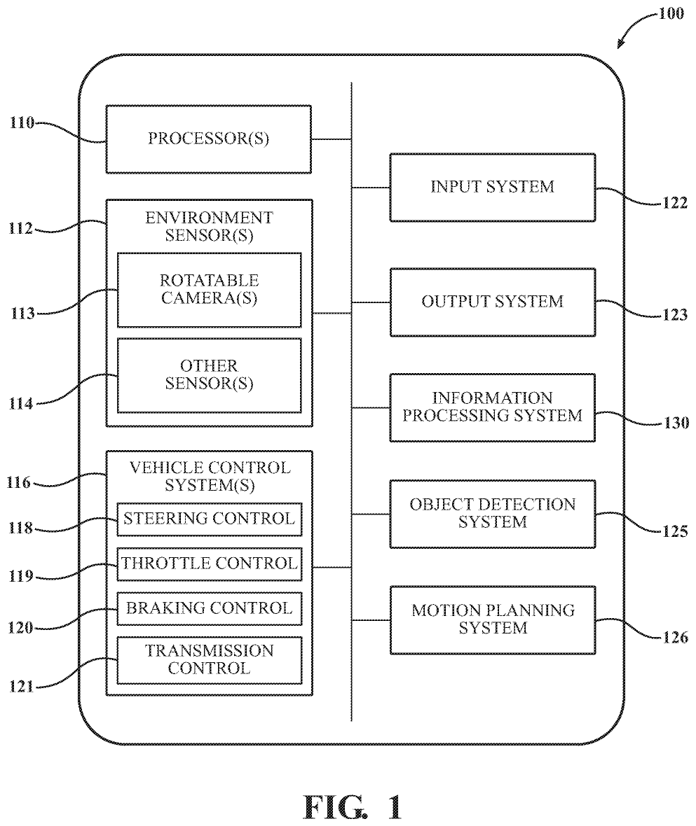

Turning our attention to the figures, FIG. 1 illustrates a block diagram of a vehicle 100 that may incorporate an information processing system 130 for processing information from a rotatable camera 113. The rotatable camera 113 may be a single rotatable camera or may be multiple rotatable cameras. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein. In other examples, instead of a vehicle 100 or another robotic device, the information processing system 130 may simply be a system that can receive information from a rotatable camera that may be arranged in any one of several different ways. For example, the information processing system 130 may be utilized to capture images from a rotatable camera mounted to a structure, such as a building.

In various embodiments, the automated/autonomous systems or combination of systems may vary. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control, as discussed in relation to the motion planning system 126

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

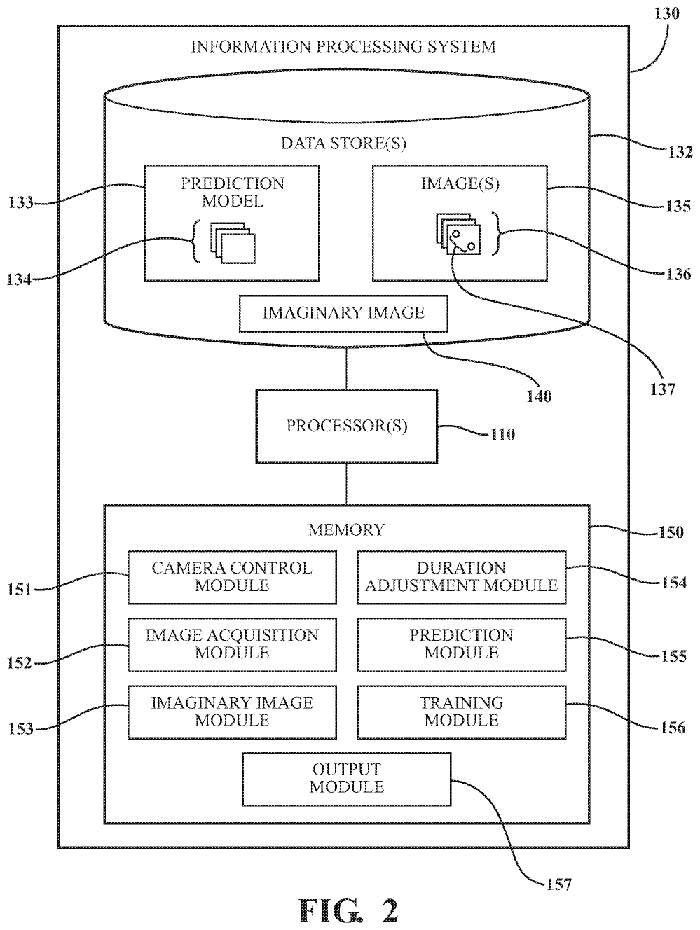

Some of the possible elements of the vehicle 100 are shown in FIG. 1 and will be described along with subsequent figures. However, a description of many of the elements in FIG. 1 will be provided after the discussion of FIGS. 2-13 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 may include the information processing system 130 and a rotatable camera 113. As will be explained in greater detail later in this specification, the rotatable camera 113 can rotate to change its field-of-view. Images captured from the rotatable camera 113 are provided to the information processing system 130, which generates an imaginary image. The imaginary image may be an image that includes objects from the images captured from the rotatable camera 113. The imaginary image can essentially have a field-of-view far greater than the field-of-view of any single captured image, as a rotatable camera 113 can rotate in several different directions to capture images from multiple fields-of-view that can be combined into the imaginary image to provide information regarding the presence of any objects located near the vehicle 100.

With reference to FIG. 2, one embodiment of the information processing system 130 is further illustrated. As shown, the information processing system 130 may include one or more processor(s) 110. Accordingly, the processor(s) 110 may be a part of the information processing system 130 or the information processing system 130 may access the processor(s) 110 through a data bus or another communication path. In one or more embodiments, the processor(s) 110 is an application-specific integrated circuit that is configured to implement functions associated with modules 151-157. In this example, the modules 151-157 include a camera control module 151, an image acquisition module 152, an imaginary image module 153, a duration adjustment module 154, a prediction module 155, a training module 156, and/or an output module 157.

In general, the processor(s) 110 is an electronic processor such as a microprocessor that is capable of performing various functions as described herein. In one embodiment, the information processing system 130 includes a memory 150 that stores the modules 151-157. The memory 150 may be a random-access memory (RAM), read-only memory (ROM), a hard disk drive, a flash memory, or other suitable memory for storing the modules 151-157. The modules 151-157 are, for example, computer-readable instructions that, when executed by the processor(s) 110, cause the processor(s) 110 to perform the various functions disclosed herein.

Furthermore, in one embodiment, the information processing system 130 includes one or more data store(s) 132. The data store(s) 132 is, in one embodiment, an electronic data structure such as a database that is stored in the memory 150 or another memory and that is configured with routines that can be executed by the processor(s) 110 for analyzing stored data, providing stored data, organizing stored data, and so on. Thus, in one embodiment, the data store(s) 132 stores data used or generated by the modules 151-157 in executing various functions.

In one embodiment, the data store(s) 132 may store one or more images 135 that may have been captured by the rotatable camera 113 of FIG. 1. The images 135 may have one or more object set(s) 136. The object set(s) 136 may be in the form of one or more objects, such as object(s) 137 that have been identified within the images 135. The data store(s) 132 may also store the imaginary image 140 that is generated based on the images 135 captured by the rotatable camera 113. As will be explained later, the imaginary image 140 is an electronic image that includes the position of the object(s) 137 from the object set(s) 136 of the images 135. As stated previously, the images 135 may be captured by the rotatable camera 113. The images 135 may be captured when the rotatable camera 113 is in a different rotatable position. The imaginary image 140 essentially combines the images 135 into an electronic image that includes different fields-of-view captured by rotatable camera 113 when the rotatable camera was in a different rotatable position. The object(s) 137 are inserted into the imaginary image 140 based on their position within the images 135.

As stated before, the imaginary image 140 is essentially an image having a field-of-view that includes the combined fields-of-view of the images 135 captured from the rotatable camera 113 as the rotatable camera 113 moves into different positions. The positions of any objects located within the imaginary image 140 are updated as new images 135 are captured by the rotatable camera 113. In addition, objects located within the imaginary image 140 that are not updated based on information from a newly captured image may be updated using a prediction model 133. As such, when the rotatable camera 113 is looking away from objects within the imaginary image 140, the prediction model 133 can update the position of these objects in the imaginary image 140 based on the predicted movement of any objects within the imaginary image.

When the rotatable camera 113 eventually returns to the field-of-view that includes the objects that were previously repositioned based on a prediction from the prediction model 133, these objects will be updated to be moved to their actual positions as indicated by the newly captured image. Additionally, as will be explained later, a comparison can be made between the predicted position of an object made by the prediction model 133 and an actual position of the object as indicated from an image captured from the rotatable camera 113. A difference value can be generated and, based on this difference value, one or more model weights 134 of the prediction model 133 can be adjusted to improve the prediction model 133. As such, the prediction model 133 may be a trainable neural network, such as a deep neural network.

With regard to the modules 151-157, the camera control module 151 functions to control the position of the rotatable camera 113. In one example, the camera control module 151 includes instructions that, when executed by the processor(s) 110, cause the processor(s) 110 to control the movement of the rotatable camera 113. For example, referring to FIG. 3, a rotatable camera 113, is situated within a protective dome 163 to protect the rotatable camera 113 from the elements. Here, the rotatable camera 113 can move in a number of different directions, such that the rotatable camera 113 can have an adjustable yaw 160 and pitch 161. Additionally, in this example, the rotatable camera 113 is mounted to a height-adjustable base 164 that allows the height 162 of the rotatable camera 113 to be adjusted. As such, the camera control module 151 can adjust the viewing angles of the rotatable camera 113 to increase the total field-of-view captured by the rotatable camera 113, as opposed to a single field-of-view that would be captured by a fixed camera that cannot adjust the yaw 160, the pitch 161, and/or the height 162.

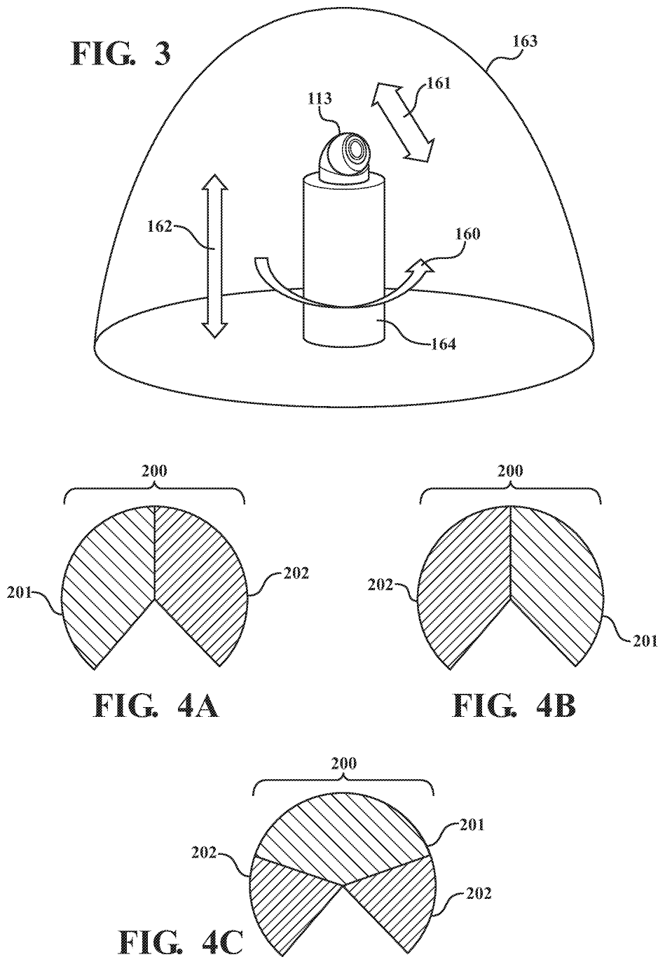

In order to better understand how the rotatable camera 113 can capture fields-of-view greater than the field-of-view of a fixed camera, reference is made to FIGS. 4A-4C. Here, images captured by the rotatable camera 113 have a field-of-view 201 of approximately 150°. It should be understood that the field-of-view 201 of images captured by the rotatable camera 113 can be any field-of-view and can be greater than or less than 150° as given in this example. The rotatable camera 113 can rotate in any one of a number of different directions. In this example, the rotatable camera 113 can adjust the yaw to rotate in a horizontal—left and right direction. As such, when positioned in such a way, the rotatable camera has a field-of-view 201, but can be rotated to include the field-of-view 202. As such, the rotatable camera 113 can capture two different images—each having a field-of-view of 150° and then, utilizing these images, generate an imaginary image that could have a field-of-view 200 of 300°.

So, with specific reference to FIG. 4A, this figure illustrates the rotatable camera 113 being rotated to the right to capture the field-of-view 201 of a scene. In this example, the image captured from the rotatable camera 113 includes the field-of-view 201, but does not include the field-of-view 202. With regard to FIG. 4B, in this example, the rotatable camera 113 has been rotated to the right to capture another field-of-view. With regards to FIG. 4C, the rotatable camera 113 has been rotated into a forward-looking position such that the image of the field-of-view 201 is a forward image, thus leaving portions of field-of-view 202 that are not part of the captured image.

With regards to the image acquisition module 152, the image acquisition module 152 causes the processor(s) 110 to acquire an image from the rotatable camera 113. As stated before, the rotatable camera 113 may be rotated in position using the camera control module 151.

The imaginary image module 153 includes instructions that, when executed by the processor(s) 110, cause the processor(s) 110 to generate an imaginary image 140. As stated previously, the imaginary image 140 may be a data structure that includes information regarding the presence of objects identified within images captured by the rotatable camera 113 when having different fields-of-view. Generally, the imaginary image 140 has a field-of-view that is greater than the field-of-view of any one single captured image, as the imaginary image 140 includes information captured from the rotatable camera 113 when the rotatable camera is in different positions. As such, in one example, the imaginary image could have a 300° field-of-view that was generated by using information from two images, each a 150° fields-of-view. The imaginary image module 153 causes the processor(s) 110 to generate this data structure.

When generating the imaginary image 140, the imaginary image module 153 may cause the processor(s) 110 to determine an object set. The object set that may be a collection of one or more objects that are located within the image. As such, an object set could include the identity of one or more objects and their positions within the captured image. Any one of several different methodologies could be utilized to detect the objects, including the use of neural networks. When generating the imaginary image 140, the imaginary image module 153 places objects from the object set within the imaginary image 140 having positions based on their positions within the captured image. As the rotatable camera 113 rotates, additional images that include additional object sets that have objects will be included within the imaginary image with their positions based on the additional captured images 135.

As stated before, the rotatable camera 113 rotates to change its field-of-view from time to time. As such, the rotatable camera will only capture an image of a field-of-view that is generally less wide than the field-of-view of the imaginary image 140. When capturing an image, the position of any objects within the image will be updated within the imaginary image 140. However, in addition to updating when capturing an image, images within the imaginary image 140 that are outside and immediately captured image may also be updated using the prediction model 133.

As such, the prediction module 155 includes instructions that may include the prediction model 133 to predict the location of objects within the imaginary image 140 at different moments in time. This is useful at times when the rotatable camera is looking away from these objects. As such, even though the rotatable camera 113 has not captured the image of these objects in the immediate present, the prediction module 155 can change the location of the objects within the imaginary image 140 based on the prediction model 133.

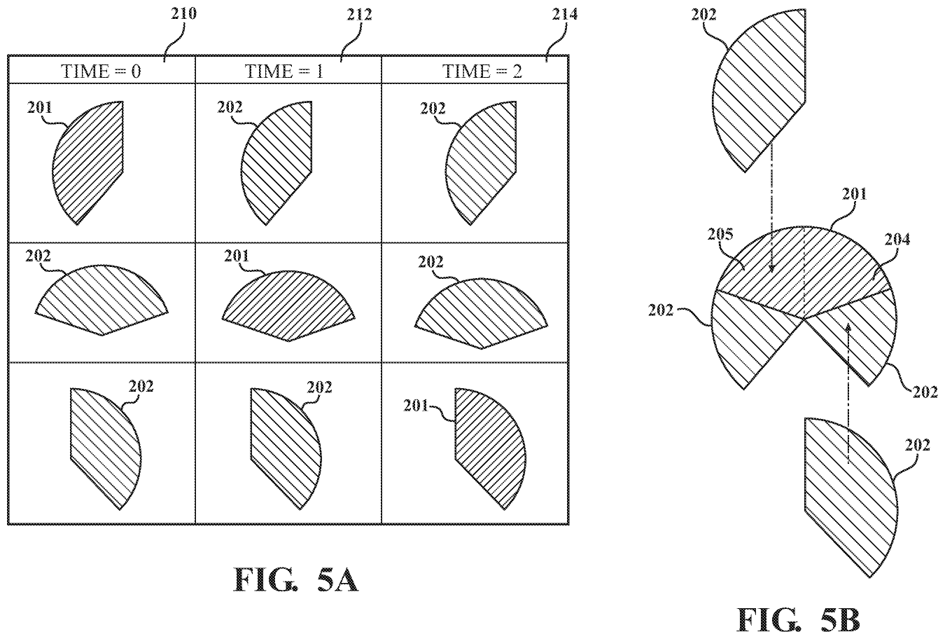

In order to better explain this, reference is made to FIG. 5A. This figure illustrates a chart that shows changes to the fields-of-view of capture images at times 0, 1, and 2, as indicated by columns 210, 212, and 214, respectively. The times 0, 1, and 2 are relative times that may have changing durations.

At time t=0, the rotatable camera 113 is rotated to have a 150° field-of-view 201. Here, any image captured by the rotatable camera 113 would only include objects located within the field-of-view 201. As such, objects located within the fields-of-view 202 would not be captured unless they partially overlap with the field-of-view 201. As such, the field-of-view 202 in the second row of column 210 is only partially captured within the field-of-view 201 in the first row of column 210. Additionally, the field-of-view 202 in the third row of column 210 is not at all within the field-of-view 201.

As such, at time t=0, the imaginary image module 153 causes the processor(s) 110 to generate an imaginary image 140 that only includes objects within the field-of-view 201. At time t=1, the rotatable camera 113 rotates approximately 75° clockwise. Here, the field-of-view 201 in the second row of column 212 is straight-ahead and includes portions of the field-of-view 202 in the first row of column 212 and the field-of-view 202 in the last row of column 212. At this moment in time, the imaginary image module 153 causes the processor(s) 110 to expand the imaginary image 140 to update the imaginary image 140 to include objects within this field-of-view 201 at time t=1. The objects located within the imaginary image 140 captured at this time will be updated based on their positions within the image captured at time t=1.

As stated before, objects located within the imaginary image 140 that are not within the field-of-view 201 at time t=1 can have their positions updated by the processor(s) 110 by using the prediction model 133. As such, while these objects may be outside the field-of-view 201 of the image captured at time t=1, these objects can still have their positions updated.

At time t=2, the rotatable camera 113 rotates clockwise approximately 75°. At this time, the field-of-view 201 is illustrated in the third row of column 214 Like before, the imaginary image module 153 causes the processor(s) 110 to update the imaginary image 140 to include objects located within this field-of-view. Additionally, like before, the prediction module 155 causes the processor(s) 110 to update the position of any objects located within the imaginary image 140 that are outside this field-of-view 201 using the prediction model 133.

As such, in the example shown in FIG. 5A, an imaginary image 140 having a 300° field-of-view can be generated using a rotatable camera 113 that is only able to capture images having a smaller field-of-view, such as 150° in this example. Objects within the imaginary image 140 that are not within the immediate field-of-view of the rotatable camera 113 can have their positions updated by the prediction model 133.

It should be understood that in some cases, the position of the camera is such that certain areas of one field-of-view may overlap certain areas of other fields-of-view. As such, referring to FIG. 5B, this example illustrates a situation occurring at time t=1 of FIG. 5A. Here, the field-of-view 201 partially overlaps portions of other fields-of-view at overlapping portions 204 and 205. As such, objects from images in these overlapping portions 204 and 205 can be used to update the imaginary image 140. As such, in this example, the position of the rotatable camera 113 is such that fields-of-view 204 and 205 receive additional attention from the rotatable camera 113. This can be useful in situations where the vehicle 100 that is mounted with a rotatable camera 113 is traveling in a forward direction and the fields-of-view 204 and 205 are generally forward of the vehicle. As such, objects located within the imaginary image 140 within the fields-of-view 204 and 205 can be updated with actual image information, as opposed to predicted positions from the prediction model 133. This may be favorable in situations where the vehicle is traveling at a fast speed in a forward direction.

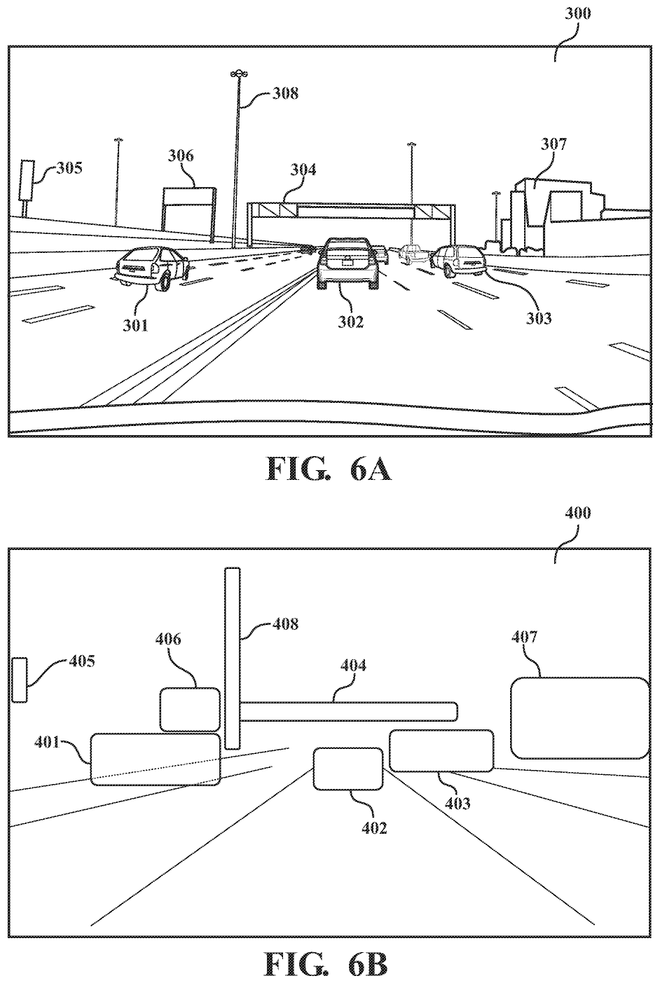

FIGS. 6A and 6B. FIG. 6A illustrates an example image 300 captured from the rotatable camera 113. Here, the image 300 includes several objects, including vehicles 301-303, as well as structures 304-308. The imaginary image module 153 can identify the objects 301-308 within the image 300 and generate an imaginary image 400, illustrated in FIG. 6B

Here, the imaginary image 400 includes data representations of the objects 401-408 that correspond to the objects 301-308 of the image 300. The objects 401-408 are placed within the imaginary image 400 to mimic the positions and/or the general shapes of the objects 301-308 within the image 300. In addition to placing the objects 401-408 within the imaginary image 400, the objects 401-408 may also include other additional information, such as object type, heading, velocity, acceleration, or other information related to the objects 401-408.

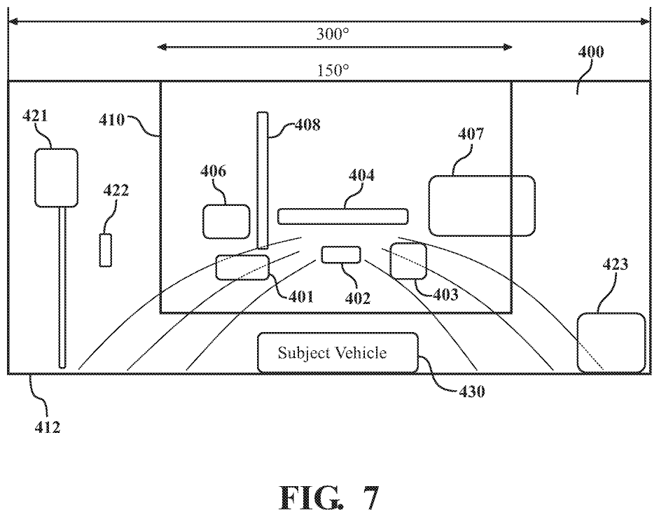

The imaginary image 400 of FIG. 6B has, in this example, a field-of-view of approximately 150°. However, stated previously, the imaginary image 400 can utilize other images captured by the rotatable camera 113 when the rotatable camera is looking in other directions to expand the field-of-view of the imaginary image 400. Referring to FIG. 7, an example of an imaginary image 412 that has been expanded to 300° is shown. Here, the imaginary image 412 includes a box 410 that delineates the imaginary image of FIG. 6B, which, as stated previously, has a 150° field-of-view. The rotatable camera 113 was able to rotate in other directions to capture images from different fields-of-view.

A confidence distribution for the objects of the imaginary image 412 may be based on object detection accuracy and focus time. In every moment, there is a view match some part of the full imaginary image 412, the sum of difference defined as (D). (D) is a vector in 3D world. The processor(s) 110 will multiply (D) by an adjustment factor (F) to make the control more reliable. The default value of (F) is 1 which means the difference (D) is 100% correct. (F) should less than 1 if the (D) overfitting or more than 1 if the (D) not enough. The factor (F) should change in different cases. Also, by changing (F), the vehicle would have different style of driving (aggressive/unaggressive), we may provide the customer some additional options in a certain safety range.

Using information from these images captured at different fields-of-view, the imaginary image module 153 can create the imaginary image 412 that has a much wider field-of-view, in this case, 300°. As such, the imaginary image 412 of FIG. 7 includes additional objects 421-423. Also shown is the subject vehicle 430 that has the rotatable camera 113 mounted to it.

As such, if we assume that the image 300 of FIG. 6A was captured at the present time, the objects 401-408 within the box 410 of the imaginary image 400 of FIG. 7 can be updated with positions from the captured image 300. Also, at or near the same kind, the position of the objects 421-423 that are outside the image 300 can have their positions updated by the prediction model 133. As such, the complete imaginary image 412 can provide information regarding the presence and location of several objects, even objects outside the field-of-view of the rotatable camera 113 at the present moment.

As stated before, the prediction model 133 may be a deep neural network having one or more model weights 134. During the training of the prediction model 133, the one or more model weights 134 are adjusted to improve the performance of the prediction model 133 with predicting the position of objects within the imaginary image 140. The prediction model 133 may be trained using any one of several different training procedures.

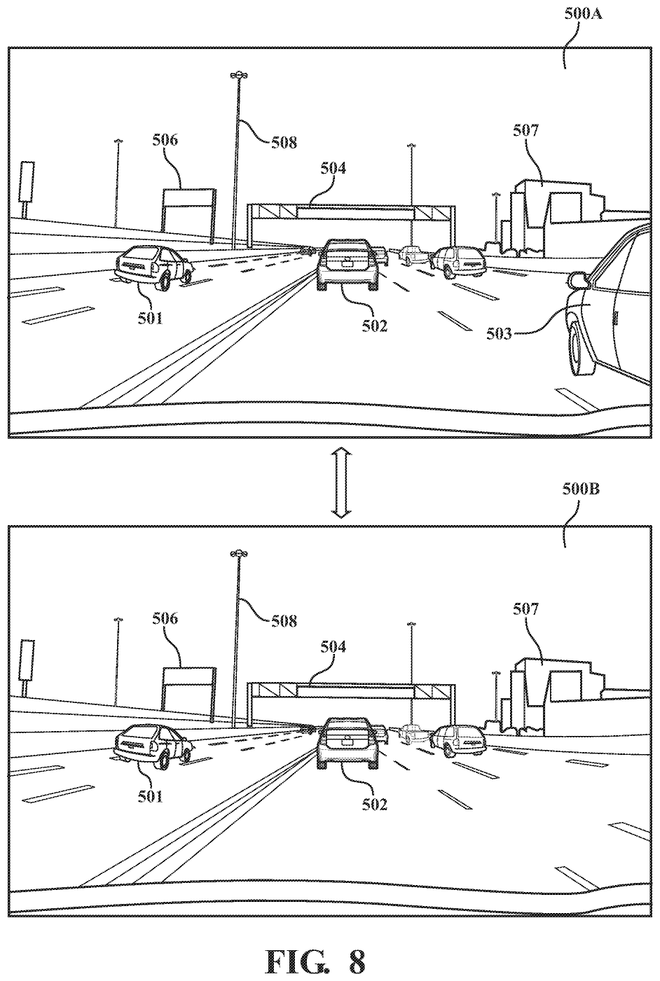

For example, FIG. 8 illustrates images 500A and 500B used to train the prediction model 133. The steps involved with training the prediction model 133, described below, may be performed by the processor(s) 110 using the training module 156. Here, the images 500A and 500B are sequential images taken at two different moments in time by a camera mounted within a moving vehicle. For simplicity's sake, the image 500A will be assumed to be taken at time t=0, and the image 500B will be assumed to be taken at time t=1. The images 500A and 500B include one or more objects 501-508.

At or around time t=0, the imaginary image module 153 creates a first imaginary image using the image 500A. At or around time t=1, the imaginary image module 153 creates a second imaginary image based on the image 500B. The second imaginary image will be utilized as a ground truth for training the prediction model 133. Also, at or around time t=1, the prediction module 155 using the prediction model 133 updates the first imaginary image with the predicted positions of the objects 501-508. As such, the first imaginary image is essentially a prediction of the position of the objects 501-508 at time t=1.

In order to train the prediction model 133, a difference value is generated by comparing the first imaginary image with the predicted positions of the objects 501-508 at time=1 with the second imaginary image, which, as stated previously, acts as a ground truth. A difference value, which could be a loss value based on the loss function, is generated. Ultimately, the training of the prediction model 133 should be such so as to minimize the difference value, which would indicate that the predicted positions of the objects in an imaginary image as predicted by the prediction model 133 substantially match the actual positions of the objects of a ground truth imaginary image. As such, during training, one or more model weights 134 of the prediction model 133 are continuously adjusted to minimize this difference value, ultimately leading to the training of the prediction model 133.

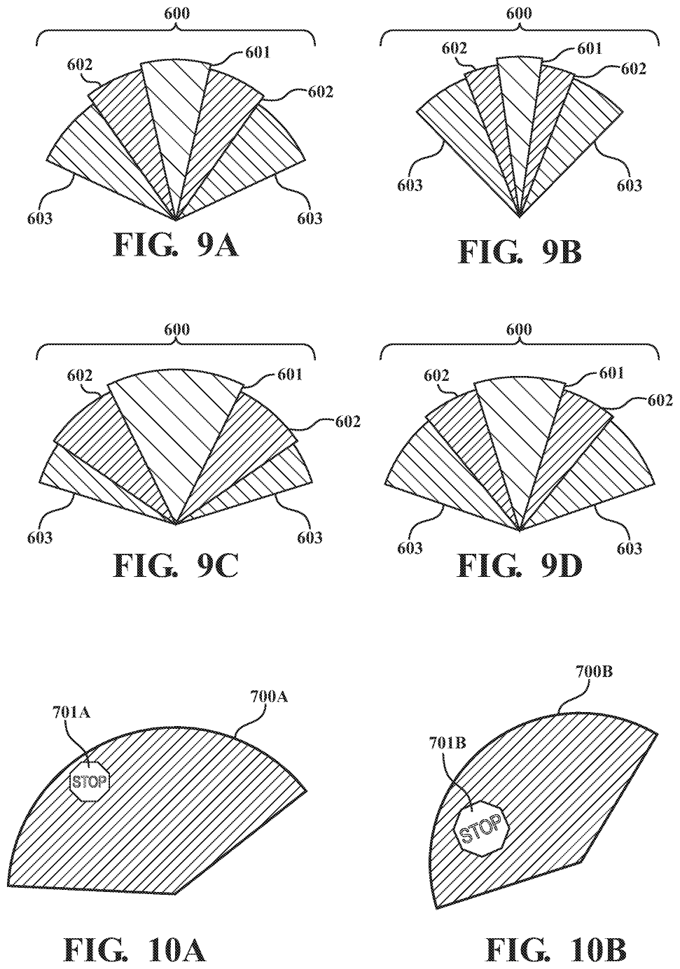

Referring back to FIG. 2, the memory 150 may include a duration adjustment module 154. The duration adjustment module 154 causes the processor(s) 110 to adjust how much time the rotatable camera 113 includes any particular field-of-view. As stated previously, it is sometimes advisable to have the rotatable camera 113 focus on a particular portion of a field-of-view based on a number of different factors. FIGS. 9A-9D illustrate different variations of different portions of a field-of-view that should be focused on based on a number of different factors.

For example, FIG. 9A-9D each illustrate a field-of-view 600 . The field-of-view 600 is broken up into three separate sections—an important section 601, a moderately important section 602, and a less important section 603. Here, the time duration of a field-of-view of the rotatable camera 113 can be adjusted such that the field-of-view of the rotatable camera 113 includes, over a period of time, the important section 601 more often than the moderately important section 602. Furthermore, the time duration may be such that the moderately important section 602 is more often within the field-of-view of the rotatable camera 113 than the less important section 603.

For example, FIG. 9A illustrates particular areas of focus when a vehicle is traveling 70 mph on a straight road. FIG. 9B illustrates an example wherein the field-of-view 600 is less than 150° and may be particularly useful in situations where the vehicle is traveling 70 mph on a curving road.

FIGS. 9C and 9D may represent the focus of the rotational camera 113 when the vehicle is traveling at a slower speed, such as 30 mph. More particularly, FIG. 9C represents the areas of particular focus when the vehicle is traveling 30 mph on a straight road, while FIG. 9D illustrates areas of particular focus when the vehicle is traveling 30 mph on a road having a curvature. It should be understood that the examples given in FIGS. 9A-9D are just examples and can be adjusted based on a number of different factors.

The duration adjustment module 154 can also cause the processor(s) 110 to adjust the rotatable camera 113 such that the rotatable camera 113 focuses on one or more particular objects that are upcoming. For example, FIG. 10A illustrates a field-of-view 700A that has a distant stop sign 701A. The duration adjustment module 154 can cause the processor(s) 110 to focus the field-of-view of the rotatable camera 113 as the vehicle 100 approaches the stop sign 701A. Here, the duration adjustment module 154 causes the processor(s) 110 to remember the stop sign 701A on the left side. In the following few seconds, the rotatable camera 113 would speed more time looking at the left side to track the stop sign 701A As such, as best shown in FIG. 10B, the field-of-view 701B will be captured by the rotatable camera 113 as the vehicle 100 approaches the now closer stop sign 701B. As such, as the vehicle approaches the stop sign 701B, by knowing the vehicle speed and heading, the camera system understand where the sign is and rotate to the left more to track the target. At some point, the camera 113 can clearly see it and tell that the object is a stop sign.

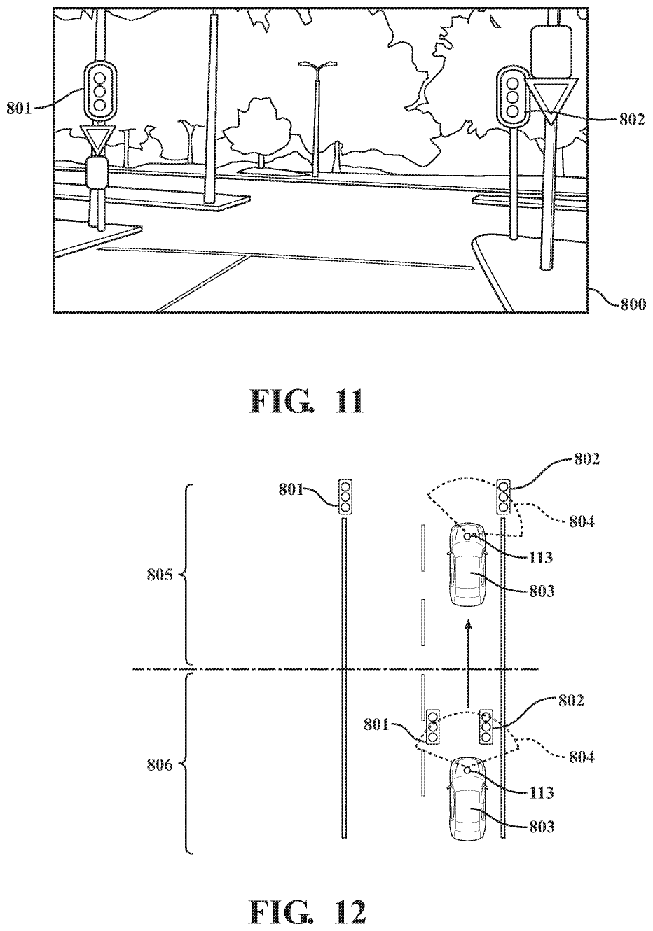

For example, FIG. 11 illustrates a scene 800 that includes two stoplights 801 and 802. In this example, the stoplights 801 and 802 are deemed to be important objects. It should be understood that, instead of stoplights, other types of important objects could also be utilized, such as other road signs, lane markers, pedestrians, bicyclists, motorcyclists, vehicles, and the like.

Here, the duration adjustment module 154 may cause the processor(s) 110 to focus on the stoplights 801 and 802. For example, FIG. 12 illustrates a scenario at two different time intervals, with time interval 806 occurring before time interval 805. At time interval 806, the rotatable camera 113 mounted to the vehicle 803 has a field-of-view 804 that includes the stoplights 801 and 802. At this distance, the stoplights 801 and 802 may not be clearly visible, such that they can be classified at stoplights 801 and 802

At time interval 805, as the vehicle 803 approaches the stoplights 801 and 802 and they become more visible, the rotatable camera 113 mounted to the vehicle 803 may focus its field-of-view, particularly on the stoplight 802, as opposed to the stoplight 801. As such, the duration adjustment module 154 adjusted the duration of the focus of the rotatable camera 113 based on the presence of one or more important objects.

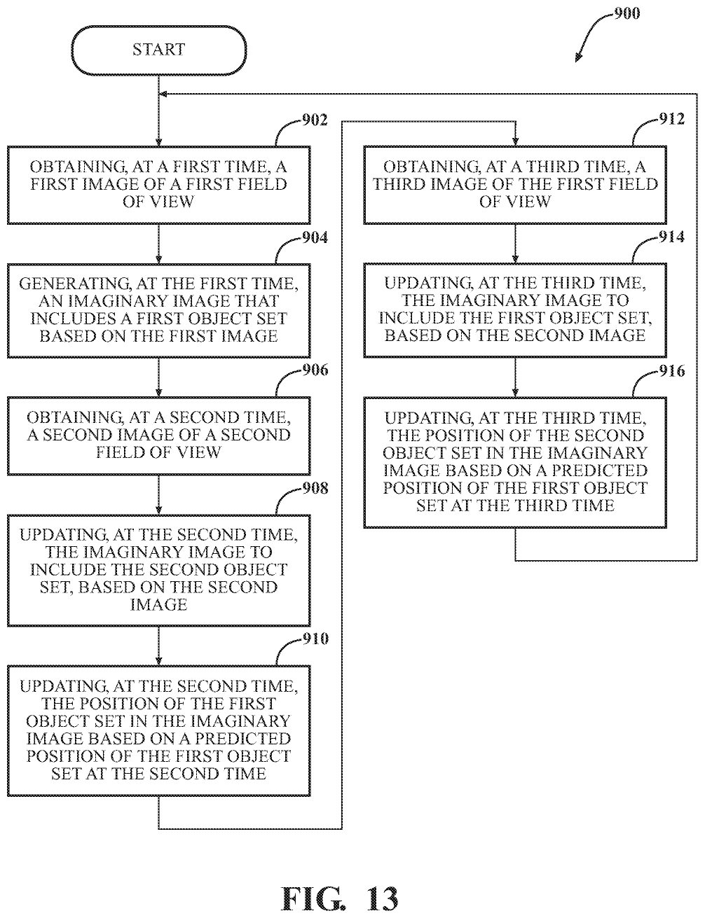

Referring to FIG. 13, a method 900 for processing information from a rotatable camera is shown. Here, the method 900 is explained from the viewpoint of the information processing system 130 of FIG. 2 and the vehicle 100 of FIG. 1. However, it should be understood that the method 900 may be practiced in any one of several different ways and are not necessarily limited to those described in relation to the information processing system 130 of FIG. 2 and the vehicle 100 of FIG. 1.

Here, the method 900 starts at step 902, wherein the image acquisition module 152 causes the processor(s) 110 to obtain, at a first time, a first image of a first field-of-view. The first field-of-view may be based on the position of the rotatable camera 113, such that rotatable camera 113 has a view of the first field-of-view.

In step 904, the imaginary image module 153 causes the processor(s) 110 to generate, at a first time, an imaginary image that includes a first objects that are within the first image. As explained previously, the first objects that may be one or more objects that have been identified within the first image. The imaginary image 140 may be generated to include these objects and other properties of the objects, such as the type of object, velocity, direction, etc.

In step 906, the image acquisition module 152 causes the processor(s) 110 to obtain, at a second time, a second image of a second field-of-view. Here, the rotatable camera 113 may be rotated to capture a second image of a second field-of-view. In step 908, at or around the second time, the imaginary image module 153 causes the processor(s) 110 to update the imaginary image 140 to include objects from the second image. As such, like before, the second image may include one or more objects that form an object set and based on the position of these objects within the second image, these objects can be inserted into the imaginary image 140.

Furthermore, as previously explained, the imaginary image 140 because it now includes information from both a first image from a first field-of-view and a second image from a second field-of-view may be essentially expanded to have a field-of-view that is greater than any of the first field-of-view and/or second field-of-view. As such, the imaginary image 140 is essentially an image that includes multiple viewpoints built on the first image and/or second image.

In step 910, the prediction module 155 causes the processor(s) 110 to update the position of objects from the first image in the imaginary image 140 based on a predicted position of these objects at the second time. For example, the prediction module 155 may include a prediction model 133 that can predict the position of these objects. As stated before, the second image taken at the second time may not include these objects from the first image at the first time. As such, in order to properly position these objects within the imaginary image 140, the prediction model 133 predicts the position of these objects within the imaginary image 140. By so doing, even though an image of these objects is not captured at this particular moment in time, a prediction of where these objects are within the imaginary image can be at least predicted.

In step 912, the rotatable camera 113 may be rotated back to the first field-of-view, wherein the image acquisition module 152 causes the processor(s) 110 to obtain a third image of the first field-of-view at a third time. In step 914, the third image is used to update the imaginary image 140. As such, objects that may have been detected in the first image and added into the imaginary image 140 can have their positions updated based on information from the third image.

In step 916, the prediction module 155 updates the position of objects within the imaginary image 140 that are not located within the third image. These may be objects that were originally located within the second image from the second field-of-view. As explained before, the purpose of the step is to update the imaginary image 140 to include positions of objects that are outside the field-of-view of the rotatable camera 113 such that the imaginary image 140 includes updated positions for all the objects, even though not all the objects may have been captured within a single image of the rotatable camera 113 at a particular moment in time.

FIG. 1 will now be discussed in full detail as an example environment within which the system and methods disclosed herein may operate. In one or more embodiments, the vehicle 100 is an autonomous vehicle, but could also be a nonautonomous or semi-autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the information processing system 130 to ensure the vehicle 100 remains within defined state constraints.

The vehicle 100 can include the processor(s) 110. In one or more arrangements, the processor(s) 110 can be a main processor of the vehicle 100. For instance, the processor(s) 110 can be an electronic control unit (ECU). The vehicle 100 can include one or more environment sensors 112. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process. Here, the environment sensors 112 can include the rotatable camera 113, which could be one or more rotatable cameras, and can also include other sensors 114. Other sensors could include sensors such as fixed cameras, sonar sensors, radar sensors, lidar sensors, and the like

The environment sensors 112 can include one or more environment sensors configured to acquire, and/or sense driving environment data. “Driving environment data” includes data or information about the external environment in which an autonomous vehicle is located or one or more portions thereof. For example, the one or more environment sensors can be configured to detect, quantify and/or sense obstacles in at least a portion of the external environment of the vehicle 100 and/or information/data about such obstacles. Such obstacles may be stationary objects and/or dynamic objects. The one or more environment sensors can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

The vehicle 100 can include an input system 122. An “input system” includes any device, component, system, element, or arrangement or groups thereof that enable information/data to be entered into a machine. The input system 122 can receive an input from a vehicle passenger (e.g., a driver or a passenger). The vehicle 100 can include an output system 123. An “output system” includes any device, component, or arrangement or groups thereof that enable information/data to be presented to a vehicle passenger (e.g., a person, a vehicle passenger, etc.).

The vehicle 100 can include one or more vehicle control system(s) 116. Various examples of the vehicle control system(s) 116 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a steering control 118 for controlling the steering of the vehicle 100, a throttle control 119 for controlling the throttle of the vehicle 100, a braking control 120 for controlling the braking of the vehicle 100, and/or a transmission control 121 for controlling the transmission and/or other powertrain components of the vehicle 100. Each of these systems can include one or more devices, components, and/or a combination thereof, now known or later developed.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can also include an object detection system 125 that receives information from the information processing system 130 and/or the environment sensors 112. Using this information, the object detection system 125 can detect one or more objects located in the environment surrounding the vehicle 100 by using the output of the environment sensors 112 and/or the imaginary image 140 produced by the information processing system 130. In some cases, the object detection system 125 may be utilized along with the information processing system 130 to generate the imaginary image 140 and, more particularly, the objects located within the imaginary image 140 from one or more captured images from the rotatable cameras 113.

The vehicle 100 can include one or more motion planning systems 126. The motion planning system 126 can be configured to receive data from the environment sensors 112 and/or any other type of system capable of capturing information relating to the vehicle 100 and/or the external environment of the vehicle 100. In one or more arrangements, the motion planning system 126 can use such data to generate one or more driving scene models. The motion planning system 126 can determine the position and velocity of the vehicle 100. The motion planning system 126 can determine the location of obstacles, obstacles, or other environmental features, including traffic signs, trees, shrubs, neighboring vehicles, pedestrians, etc.

The motion planning system 126 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

The systems, components, and/or processes described above can be realized in hardware or a combination of hardware and software. They can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which, when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A system for processing information from a rotatable camera, the system comprising:
one or more processors; and
a memory in communication with the one or more processors, the memory having:
an image acquisition module having instructions that, when executed by the one or more processors, cause the one or more processors to obtain, at a first time, a first image of a first field-of-view from the rotatable camera when the rotatable camera is in a first position, the first image having a first object set, the first object set being one or more objects identified within the first image,
an imaginary image module having instructions that, when executed by the one or more processors, cause the one or more processors to generate, at the first time, an imaginary image that includes the first object set, a position of the first object set within the imaginary image being based on the first image, the imaginary image being an electronic image having an imaginary field-of-view greater than the first field-of-view,
the image acquisition module further having instructions that, when executed by the one or more processors, cause the one or more processors to obtain, at a second time, a second image from the rotatable camera when the rotatable camera is in a second position of a second field-of-view, the second image having a second object set, the second object set being one or more objects identified within the second image,
the imaginary image module further having instructions that, when executed by the one or more processors, cause the one or more processors to update, at the second time, the imaginary image to include the second object set, a position of the second object set within the imaginary image being based on the second image, the imaginary field-of-view that includes the first object set and the second object set, the imaginary field-of-view being greater than the second field-of-view, and
the imaginary image module further having instructions that, when executed by the one or more processors, cause the one or more processors to update, at the second time, the position of the first object set in the imaginary image based on a predicted position of the first object set at the second time.

2. The system of claim 1, wherein:
the image acquisition module further having instructions that, when executed by the one or more processors, cause the one or more processors to obtain, at a third time, a third image from the rotatable camera when the rotatable camera is in the first position;
the imaginary image module further having instructions that, when executed by the one or more processors, cause the one or more processors to update, at the third time, the position of the first object set based on the third image; and
the imaginary image module further having instructions that, when executed by the one or more processors, cause the one or more processors to update, at the third time, the position of the second object set based on a predicted position of the second object set at the third time.

3. The system of claim 2, further comprises:
the rotatable camera mounted to a vehicle; and
wherein the memory further comprises a duration adjustment module, the duration adjustment module having instructions that, when executed by the one or more processors, cause the one or more processors to adjust a duration of at least one of the first time, the second time and the third time, based on a speed of the vehicle, the rotatable camera being mounted to the vehicle.

4. The system of claim 2, wherein the memory further comprises a duration adjustment module, the duration adjustment module having instructions that, when executed by the one or more processors, cause the one or more processors to adjust a duration of at least one of the first time, the second time and the third time, based on an object type of at least one of the one or more objects of the first object set or the second object set.

5. The system of claim 2, wherein the memory further comprises:
a prediction module having instructions that, when executed by the one or more processors, cause the one or more processors to determine a predicted position of the first object set at the third time using a prediction model;
a training module having instructions that, when executed by the one or more processors, cause the one or more processors to generate a difference value by comparing the predicted position of the first object set at the third time with the position of the first object set based on the third image; and
the training module further having instructions that, when executed by the one or more processors, cause the one or more processors to update one or more model weights of a prediction model based on the difference value, the prediction model configured to predict the predicted position the first object or the second object set at a future time.

6. The system of claim 5, wherein the prediction model is a deep neural network.

7. The system of claim 1, the imaginary image module further having instructions that, when executed by the one or more processors, cause the one or more processors to update, at the second time, the position of the one or more objects of the first object set that are present in the second image.

8. The system of claim 1, wherein the memory further comprises an output module having instructions that, when executed by the one or more processors, cause the one or more processors to output the imaginary image to an object detection system of a vehicle.

9. A method for processing information from a rotatable camera, the method comprising the step of:
obtaining, at a first time, a first image of a first field-of-view from the rotatable camera when the rotatable camera is in a first position, the first image having a first object set, the first object set being one or more objects identified within the first image;
generating, at the first time, an imaginary image that includes the first object set, a position of the first object set within the imaginary image being based on the first image, the imaginary image being an electronic image having an imaginary field-of-view greater than the first field-of-view;
obtaining, at a second time, a second image from the rotatable camera when the rotatable camera is in a second position of a second field-of-view, the second image having a second object set, the second object set being one or more objects identified within the second image;
updating, at the second time, the imaginary image to include the second object set, a position of the second object set within the imaginary image being based on the second image the imaginary field-of-view that includes the first object set and the second object set, the imaginary field-of-view being greater than the second field-of-view; and
updating, at the second time, the position of the first object set in the imaginary image based on a predicted position of the first object set at the second time.

10. The method of claim 9, further comprising the steps of:
obtaining, at a third time, a third image from the rotatable camera when the rotatable camera is in the first position;
updating, at the third time, the position of the first object set based on the third image; and
updating, at the third time, the position of the second object set based on a predicted position of the second object set at the third time.

11. The method of claim 10, further comprising the step of adjusting a duration of at least one of the first time, the second time and the third time, based on a speed of a vehicle, the rotatable camera being mounted to the vehicle.

12. The method of claim 10, further comprising the step of adjusting a duration of at least one of the first time, the second time and the third time, based on an object type of at least one of the one or more objects of the first object set or the second object set.

13. The method of claim 10, further comprising the steps of:
determining a predicted position of the first object set at the third time;
generating a difference value by comparing the predicted position of the first object set at the third time with the position of the first object set based on the third image; and
updating one or more model weights of a prediction model based on the difference value, the prediction model configured to predict the predicted position the first object or the second object set at a future time.

14. The method of claim 13, wherein the prediction model is a deep neural network.

15. The method of claim 9, further comprising the step of updating, at the second time, the
the position of the one or more objects of the first object set that are present in the second image.

16. The method of claim 9, further comprising the step of outputting the imaginary image to an object detection system of a vehicle.

17. A non-transitory computer-readable medium storing instructions that, when executed by one or more processors, cause the one or more processors to:
obtain, at a first time, a first image of a first field-of-view from a rotatable camera when the rotatable camera is in a first position, the first image having a first object set, the first object set being one or more objects identified within the first image;
generate, at the first time, an imaginary image that includes the first object set, a position of the first object set within the imaginary image being based on the first image, the imaginary image being an electronic image having an imaginary field-of-view greater than the first field-of-view;
obtain, at a second time, a second image from the rotatable camera when the rotatable camera is in a second position of a second field-of-view, the second image having a second object set, the second object set being one or more objects identified within the second image, the imaginary field-of-view that includes the first object set and the second object set, the imaginary field-of-view being greater than the second field-of-view;
update, at the second time, the imaginary image to include the second object set, a position of the second object set within the imaginary image being based on the second image; and
update, at the second time, the position of the first object set in the imaginary image based on a predicted position of the first object set at the second time.

18. The non-transitory computer-readable medium of claim 17, further comprising instructions that, when executed by one or more processors, cause the one or more processors to:
obtain, at a third time, a third image from the rotatable camera when the rotatable camera is in the first position;
update, at the third time, the position of the first object set based on the third image; and
update, at the third time, the position of the second object set based on a predicted position of the second object set at the third time.

19. The non-transitory computer-readable medium of claim 18, further comprising instructions that, when executed by one or more processors, cause the one or more processors to adjust a duration of at least one of the first time, the second time and the third time, based on at least one of:
a speed of a vehicle, the rotatable camera being mounted to the vehicle; and
an object type of at least one of the one or more objects of the first object set or the second object set.

20. The non-transitory computer-readable medium of claim 18, further comprising instructions that, when executed by one or more processors, cause the one or more processors to:
determine a predicted position of the first object set at the third time;
generate a difference value by comparing the predicted position of the first object set at the third time with the position of the first object set based on the third image; and
update one or more model weights of a prediction model based on the difference value, the prediction model configured to predict the predicted position the first object or the second object set at a future time.
